(19) United States
(12) Patent Application Publication
(10) Pub. No.: US 2016/0121813 A1
(43) Pub. Date: May 5, 2016

(54) INSERT FOR A MOTOR VEHICLE SEAL

(71) Applicant: GM GLOBAL TECHNOLOGY OPERATIONS LLC, Detroit, MI (US)

(72) Inventors: Klaus-Albert PRIESS, Mainz (DE); Michael ALHOF, Florsheim (DE)

(73) Assignee: GM GLOBAL TECHNOLOGY OPERATIONS LLC, Detroit, MI (US)

(21) Appl. No.: 14/927,010

(22) Filed: Oct. 29, 2015

(30) Foreign Application Priority Data
Oct. 29, 2014 (DE) 102014016043.2
Apr. 24, 2015 (DE) 102015005289.6

(51) Int. Cl. B60R 13/06; F16J 15/12

(52) U.S. Cl. CPC B60R 13/06; F16J 15/121

(57) ABSTRACT

The present disclosure relates to an insert for a motor vehicle seal, with multiple frames connected to one another via webs. The webs have adjacent first legs with outer face ends along an insert longitudinal axis. A minimum distance of the outer face ends of the first legs of first frames to a bending axis of these legs is smaller than a maximum distance of the outer face ends of the first legs of second frames to the bending axis of the first legs of the first frames.

### CROSS-REFERENCE TO RELATED APPLICATIONS

This application claims priority to German Patent Application No. 102014016043.2, filed Oct. 29, 2014 and German Patent Application No. 102015005289.6, filed Apr. 24, 2015, which are incorporated herein by reference in their entirety.

### TECHNICAL FIELD

The present disclosure relates to an insert for a motor vehicle seal, a motor vehicle seal having such an insert, a motor vehicle having such a motor vehicle seal, an insert arrangement with at least two such inserts and a method for producing such an insert arrangement.

### BACKGROUND

DE 37 43 970 A1 discloses a metal reinforcement for a U-shaped fitted profile for motor vehicles. This insert includes a series of U-shaped frames, which are connected to one another by webs. The outer face ends of the legs of the U-shaped frames all have the same distance to a folding axis of the webs.

### SUMMARY

According to an aspect of the present disclosure, an insert for a motor vehicle seal, in particular an insert of a motor vehicle seal, includes multiple frames which are arranged along an insert respectively motor vehicle seal longitudinal axis and connected to one another via one or multiple webs each. In an embodiment, an insert that can be advantageously bent in the insert longitudinal axis and/or twisted about this insert longitudinal axis can be advantageously made available in an embodiment.

In an embodiment, the frames each include first legs which are arranged on the same side of the insert longitudinal axis respectively adjacent located opposite one another along the insert longitudinal axis, extend in a leg longitudinal direction transversely, in particular perpendicularly to the insert longitudinal axis and on the side facing away from the insert longitudinal axis respectively are located opposite the same each end in an outer face end which in an embodiment can be curved, in particular wave-like, in another embodiment jagged or crenellated and in a further embodiment can be flat, in particular rectangular.

The first legs include a bending axis along which they are angled in an assembly state, in particular through forming, in particular by at least 45°, in particular at least 60°, in particular at least 80°. In a production state, in which the insert prior to the angling can be formed flat, the bending axis of the first legs in terms of the present disclosure can run in particular through transitions between frames and webs or parallel thereof and/or be defined by the provided assembly state. Accordingly, a bending axis can be in particular an axis which is provided for the first legs being angled along this axis when the insert includes an assembly state.

According to an aspect of the present disclosure, a minimal distance of the outer face ends of the first legs of first frames to the bending axis of these legs in a direction perpendicular to this bending axis, in particular in leg longitudinal direction, is smaller than a maximum distance of the outer face ends of the first legs of second frames to this bending frames of the first legs of the first frames in a direction perpendicular to this bending axis, in particular in leg longitudinal direction.

In an embodiment, the insert thereby advantageously includes on the one hand a large outer dimension respectively maximum extension perpendicularly to its insert longitudinal axis which can be defined in particular through the larger maximum distance of the outer face ends of the first legs of the second frames, on the other hand a low weight, which can be reduced through the minimal distance of the outer face ends of the first legs of the first frames that is smaller.

In an embodiment, the betiding axes of the first legs of the first and second frames are identical respectively form a common bending axis. In another embodiment, the bending axis of the first legs of the second frames is spaced from the bending axis of the first legs of the first frames, in particular in parallel. In an embodiment, the bending axis of the first legs of the first and/or second frames, in particular the common bending axis of the first legs of the first and second frames is parallel to the insert longitudinal axis and/or stands perpendicularly on an extension or longitudinal direction of the first legs.

In an embodiment, the maximum distance of the outer face ends of the first legs of the second frames is larger by at least 0.75 mm, in particular at least 1.0 mm, in particular at least 1.25 mm, and/or by at least 0.5%, in particular at least 1.0%, in particular at least one 1.5% of the maximum distance of the outer face ends of the first legs of the second frames than the minimal distance of the outer face ends of the first legs of the first frames. Because of this, an advantageous outer dimension with an advantageous weight can be realized in an embodiment.

According to an aspect of the present disclosure, the outer face ends of the first legs of the first frames and/or the outer face ends of the first legs of the second frames arc parallel to the bending axis of the first leas of the first frames, in particular of the common bending axis or include an angle with the same that is a maximum of 5°, a maximum of 1°, preferentially approximately 0°. This can in particular improve the support via the face ends and/or the production and/or handling of the insert.

Outer face ends which are parallel to the bending axis have in an embodiment, in which the face ends are flat, over the entire width of the legs in the direction of the insert longitudinal axis, at least substantially the same distance to the bending axis. Accordingly, the first legs of the first frames in leg longitudinal direction are shorter in an embodiment than the first legs of the second frames.

In an embodiment, in which the face ends are crenellated (i.e., open at the face end), outer face ends which are parallel to the bending axis alternately include at least ubstantially constantly larger and at least substantially constantly smaller distances over the width of the legs in the direction of the insert longitudinal axis, in particular alternately an at least substantially constantly larger distance and an at least substantially constantly smaller distance to the bending axis of the first legs of the first frames, in particular of the common bending axis. In an embodiment, crenellated face ends of the first legs of the first frames and crenellated face ends of the first legs of the second frames have the same maximum and/or minimum distance, in particular, the first legs of the first frames can have the same length in leg longitudinal direction in an embodiment as the first legs of the second frames.

According to an aspect of the present disclosure, the outer face ends of the first legs of the first frames and/or the outer face ends of the first legs of the second frames are inclined over their entire width or extension in the direction of the insert longitudinal axis or a part of this extension against the bending axis of the first legs of the first frames, in particular the common bending axis or include an angle with the same which in an embodiment is at least 10°, in particular at least 15°, in particular at least 30°. Here, the outer face ends can be designed flat and over their entire extension in the direction of the insert longitudinal axis includes at least substantially the same angle with the bending axis. Equally, the outer face ends can be designed jagged and over their extension in the direction of the insert longitudinal axis include in sections with the bending axis angles that are in opposite direction, in particular the same in the amount. This can in particular improve the outer contour of the insert.

Outer face ends inclined against the insert longitudinal axis include in an embodiment over the width of the legs in the direction of the insert longitudinal axis a distance to the bending axis which reduces in particular monotonously, in particular strictly monotonously from a maximum to a minimum distance.

The outer face ends of the first legs of the first frames and the outer face ends of the first legs of the second frames in an embodiment can be inclined in the same direction against the bending axis of the first legs of the first frames, in particular the common bending axis. Because of this, a saw tooth-like outer contour of the insert can be realized in an embodiment. Equally, the outer face ends of the first legs of the first frames and the outer face ends of the first legs of the second frames in another embodiment can also be inclined in opposite direction against the bending axis of the first legs of the first frames, in particular the common bending axis. Because of this, a garden fence-like outer contour of the insert can he realized in an embodiment.

In an embodiment, the outer face ends of the first legs of the first frames which over their entire extension in the direction of the insert longitudinal axis or a part of this extension are inclined against the bending axis and the outer face ends of the first legs of the second frames which over their entire extension in the direction of the insert longitudinal axis or a part of this extension are inclined against the bending axis have the same maximum and/or minimum distance to the bending axis of the first legs of the first frames, in particular of the common bending axis, in particular, the first legs of the first frames can have the same length in leg longitudinal direction in an embodiment as the first legs of the second frames. In another embodiment, in which the outer face ends of the first legs are inclined against the bending axis, the first legs of the first frames are shorter or longer in leg longitudinal direction than the first legs of the second frames.

According to an aspect of the present disclosure, the outer face ends of the first legs of the first frames and/or the outer face ends of the first legs of the second frames are curved against the bending axis of the first legs of the first frames, in particular the common bending axis, in particular designed wave-like. This can in particular improve the outer contour of the insert.

Outer face ends which are curved against the bending axis include in an embodiment a distance to the bending axis over the width of the legs in the direction of the insert longitudinal axis which, in particular singly or multiply, varies between a maximum and a minimum distance, for example sinusoidal.

In an embodiment, the outer face ends of the first leas of the first frames that are curved against the bending axis and the outer face ends of the first legs of the second frames which are curved against the bending axis of the first legs of the first frames, in particular the common bending axis have the same maximum and/or minimal distance to the bending axis, in particular, the first legs of the first frames in lea longitudinal direction in an embodiment can have the same length as the first legs of the second frames.

In an embodiment, groups of one or multiple first frames each and groups of one or multiple second frames each are adjacent along the insert longitudinal axis.

In an embodiment, the insert can additionally include other frames that are distinct from the first and second frames. For example, a first frame, adjacent to this a second frame, adjacent to this another frame, adjacent to this a second frame and adjacent to this again a first frame can be arranged along the insert longitudinal axis. The outer face ends of the first legs of such other frames can have a minimum and/or maximum distance from the bending axis of the first legs of the first frames that is greater or smaller than the minimum or maximum distance of the first legs of the first and/or second frames. In particular, the first legs of other frames can also be shorter or longer than the first legs of the first and/or second frames.

In an embodiment, the insert includes only first and second frames so that the groups of one or multiple first frames each and groups of one or multiple second frames each are alternately adjacent along the insert longitudinal axis. For example, a first frame and a second frame can always be arranged along alternately the insert longitudinal axis, always alternately a first and two second frames, always alternately two first and a second frame or always alternately two first and two second frames.

In an embodiment, the first frames and/or the second frames each include a second leg which is located opposite the first lea in leg longitudinal direction respectively arranged on the other side of the insert longitudinal axis, which in each case ends in an outer face end on the side facing away from the insert longitudinal axis respectively located opposite the first leg of the frame.

The outer face ends of the second legs of the first frames and the outer face ends of the second legs of the second frames in an embodiment includes at least substantially the same maximum and/or minimum distance to the bending axis of the first legs of the first frames in a direction perpendicular to the bending axis, in particular in leg longitudinal direction. In an embodiment, the outer face ends of the second legs of the first frames and/or the outer face ends of the second legs of the second frames are flat, in particular rectangular, and/or parallel to the bending axis of the first legs of the first frames, respectively include with the same an angle that is a maximum of 5°, in particular a maximum of 1°, preferentially approximately 0°. This can in particular improve the support via the face ends and/or the production and/or handling of the insert.

In an embodiment, the first and second legs of the first and/or second frames with respect to the adjoining webs respectively insert longitudinal axis are at least substantially symmetrically or identical in length or their outer face ends, have at least substantially the same maximum and/or minimum distance to a web middle. In another embodiment, the first and second legs of the first and/or second frames with respect to the webs respectively insert longitudinal axis are asymmetrical or uneven in length or their outer face ends have different maximum and/or minimum distances to a web middle. In particular, the second webs of the first and/or second frames can be shorter than the first webs of these frames.

In an embodiment, the insert is severingly produced from an in particular coated or uncoated plate in particular an aluminum or steel plate in particular stainless steel plate in particular through punching and/or cutting. The severing can be followed by stretching or drawing or elongating in the direction of the insert longitudinal axis, in particular in order to space or pull first legs or frames apart in the direction of the insert longitudinal axis.

According to an aspect of the present disclosure, an in particular flat insert arrangement includes two or more of the inserts described here, which are adjacent in leg longitudinal direction. During the production, in particular the severing, a first and a second insert of at least one pair of these inserts, which have parallel insert longitudinal axes, are interlaced with one another or alternately engage into one another in leg longitudinal direction.

Accordingly, the outer face ends of the first legs of the first frames of a first insert in an embodiment and the outer face ends of the first legs of the second frames of a second insert of the insert arrangement that is adjacent with parallel insert longitudinal axis in leg longitudinal direction are severed in a common separation plane, or form a common separation plane for respectively during their production.

When in an embodiment the outer flat face ends of the first legs are parallel to the bending axis of the first legs of the first frames and/or the first legs of the first frames are shorter than the first legs of the second frames the first legs of the second frames of the first insert in an embodiment and the first legs of the second frames of the second insert alternately engage over one another in leg longitudinal direction respectively transversely to the insert longitudinal axis.

When in another embodiment the outer flat face ends of the first legs are inclined against the insert longitudinal axes, a maximum distance of an outer face end of a first leg of the first insert to its bending axis of the first leg of the first frame is located opposite a minimal distance of an outer face end of a first leg of the second insert to its bending axis of the first legs of the first frames and conversely a minimal distance of an outer face end of a first leg of the first insert to its bending axis of the first legs of the first frame opposite a maximum distance of an outer face end of a first leg of the second insert to its bending axis of the first leg of the first frame.

When in another embodiment the outer face ends of the first legs are jagged, crenellated or wave-like, a maximum distance of an outer face end of a first leg of the first insert in an embodiment to its bending axis of the first legs of the first frames opposite a minimum distance of an outer face end of a first leg of the second insert to its bending axis of the first legs of the first frames and conversely a minimum distance of an outer face end of a first leg of the first insert to its bending axis of the first legs of the first frames opposite a maximum distance of an outer face end of a first leg of the second insert to its bending axis of the first legs of the first frames.

In an embodiment, the frames are U-shaped in an assembly state, wherein their first and second legs can be connected to one another in particular by a center web, against which both legs in an embodiment are angled in opposite directions by at least 45°. In another embodiment, the frames in an assembly state are V-shaped, their first and second legs merging into one another and in an embodiment being angled against one another by at least 45°. In an embodiment, the frames, in particular following the severing, are formed U or V-shaped, in particular before or after a pulling apart in the direction of the insert longitudinal axis.

According to an aspect of the present disclosure, a motor vehicle seal includes a profile, in particular of plastic and/or rubber, and an insert described here, which is completely or partly arranged in the profile. The insert can in particular be pushed into an existing hollow space of the profile and in a further development be fixed in the same in a further development in a positively joined, frictionally joined and/or materially joined manner, in particular through forming of the insert arranged in the profile. Equally, the insert, in an embodiment, can be molded into the profile, in particular during the casting of the profile.

According to an aspect of the present disclosure, a motor vehicle, in particular a passenger car includes a motor vehicle seal described here which, is connected to a body and/or covering of the motor vehicle in particular in a positively joined, frictionally joined and/or materially joined manner. The seal in this case can in particular be a secondary seal. When the insert of the motor vehicle seal as described here in an embodiment includes frames with first and second legs, wherein the outer face ends of the second legs have the same distance to the bending axis of the first legs of the first frames, these second legs can be arranged in particular on the vehicle inside or outside.

### BRIEF DESCRIPTION OF THE DRAWINGS

The present disclosure will hereinafter be described in conjunction with the following drawing figures, wherein like numerals denote like elements.

FIG. 1A illustrates a part of an insert arrangement according to an embodiment of the present disclosure;

FIG. 1B illustrates a part of an insert of the insert arrangement;

FIG. 1C illustrates a part of a motor vehicle seal with an insert in the section along the line C-C in FIG. 1B;

FIG. 2A illustrates a part of an insert arrangement according to a further embodiment of the present disclosure in representation corresponding to FIG. 1A;

FIG. 2B illustrates a part of an insert of the insert arrangement of FIG. 2A;

FIG. 2C illustrates a part of a motor vehicle seal with the insert of FIG. 2B in section along the line C-C in FIG. 2B;

FIG. 3A is a perspective view of a motor vehicle seal according to a further embodiment of the present disclosure; and

FIG. 3B is a perspective view of a modification of the motor vehicle seal of FIG. 3A according to a further embodiment of the present disclosure in representation corresponding to FIG. 3A.

### DETAILED DESCRIPTION

The following detailed description is merely exemplary in nature and is not intended to limit the present disclosure or the application and uses of the present disclosure. Furthermore, there is no intention to be bound by any theory presented in the preceding background of the present disclosure or the following detailed description.

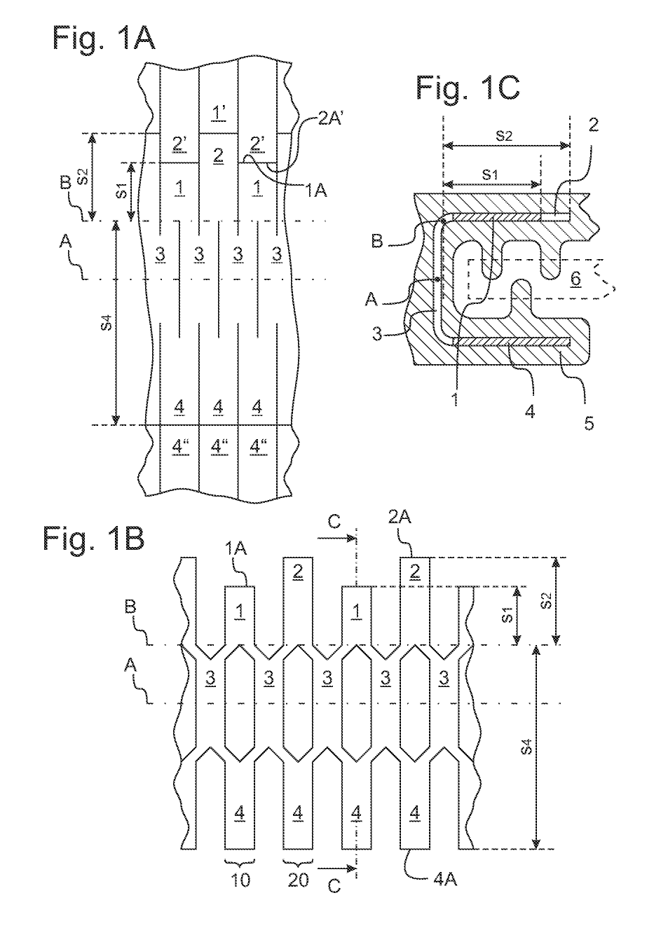

FIG. 1A shows part of an insert arrangement with three inserts according to an embodiment of the present disclosure in a finished state. The inserts are identical in construction and are explained in more detail in the following with reference to the middle insert in FIG. 1A, which is arranged separately from the other two inserts in FIG. 1B and in FIG. 1C arranged in an assembly state in a profile 5 of plastic or rubber. To distinguish, the reference numbers of the in FIG. 1, upper inserts are differentiated by a single prime (′) and lower inserts with a double prime (″) in FIGS. 1A-1C.

The inserts each include first frames 10 and second frames 20 (see FIG. 1B), which are alternately adjacently arranged along an insert longitudinal axis A indicated in dashed-dotted line in the figures and are connected to one another via webs 3. The frames 10, 20 each include first legs 1 and 2 respectively, which are arranged on the same side of the insert longitudinal axis A (top in FIG. 1A-1C), extend in a leg longitudinal direction perpendicularly to the insert longitudinal axis A and on the side facing away from the insert longitudinal axis A each terminate in a rectangular outer face end 1A respectively 2A. In the embodiment of FIG. 1A-1C, these outer face ends 1A, 2A of the first legs 1, 2 are parallel to the insert longitudinal axis A.

The first legs 1, 2 of the first and second frames are angled by approximately 90° in the assembly stage shown in FIG. 1C along a common bending axis B, which in the production stage shown in FIG. 1A, 1B exemplarily runs through the transitions between these legs 1, 2 and the webs 3 and is spaced parallel from the insert longitudinal axis A. Here, the first legs 1 of the first frames 10 are shorter in leg longitudinal direction than the first legs 2 of the second frames 20. Accordingly, a minimum distance s₁ of the outer face ends 1A of the first legs 1 of the first frames 10 to the common bending axis B in leg longitudinal direction perpendicularly to the bending axis B is smaller than a maximum distance s₂ of the outer face ends 2A of the first legs 2 of the second frames 20 in leg longitudinal direction to this bending axis B.

The first frames 10 and the second frames 20 each include a second leg 4 located opposite the first leg 1 and 2 respectively in leg longitudinal direction and arranged on the other side of the insert longitudinal axis A (bottom in FIG. 1a-1C), which on the side facing away from the insert longitudinal axis A ends in an outer face end 4A each. The outer face ends 4A of the second legs 4 of the first frames 10 and second frames 20 have the same distance s₄ to the common bending axis B of the first legs 1, 2 and are parallel to the same. In a concrete embodiment, the length (s₁+s₄) of the first frames 10 is for example 35 mm and the length (s₂+s₄) of the second frames 20 is 36.5 mm.

The inserts or the insert arrangement are produced from a coated or uncoated metal plate by punching and/or cutting. To this end, FIG. 1A shows a part of the flat insert arrangement with the three inserts, which are adjacent in leg longitudinal direction (vertical in FIG. 1A). As is evident from viewing FIG. 1A and FIG. 1B together, the outer face ends 1A of the first legs 1 of the first frames 10 of the in FIG. 1A middle first insert and the outer face ends 2A′ of the first legs 2′ of the second frames of the in FIG. 1A upper, second insert which is adjacent with parallel insert longitudinal axis in leg longitudinal direction are severed in a common separation plane (1A, 2A′). Accordingly, the first legs 2 of the second frames 20 of the in FIG. 1A middle, first insert and the first legs 2′ of the second frames of the in FIG. 1A upper, second insert engage over one another alternately in leg longitudinal direction respectively transversely to the insert longitudinal axis A.

Equally, the outer face ends 2A of the first legs 1 of the second frames 20 of the in FIG. 1 a middle, first insert and the outer face ends of the first legs 1′ of the first frames of the in FIG. 1A upper, second insert, the outer face ends of the second legs 4, 4″ of the in FIG. 1A middle and lower insert and the flanks are each severed into common separation planes perpendicularly to the insert longitudinal axis A of the legs 1, 2, 2′, 4, 4″ and the webs 3.

Following this severing, the inserts are pulled apart in the direction of the insert longitudinal axis A so that their first and second legs 1, 2, 4 which are spaced in the direction of the insert longitudinal axis A and opening slots form the webs 3, as is evident in particular from the Figure sequence 1A→B. Following this pulling apart in the direction of the insert longitudinal axis A, the inserts are formed U-like and pushed into profiles 4 in order to form motor vehicle seals, which are connected to a body and/or paneling 6 of a passenger car as is exemplarily indicated in the section of FIG. 1C.

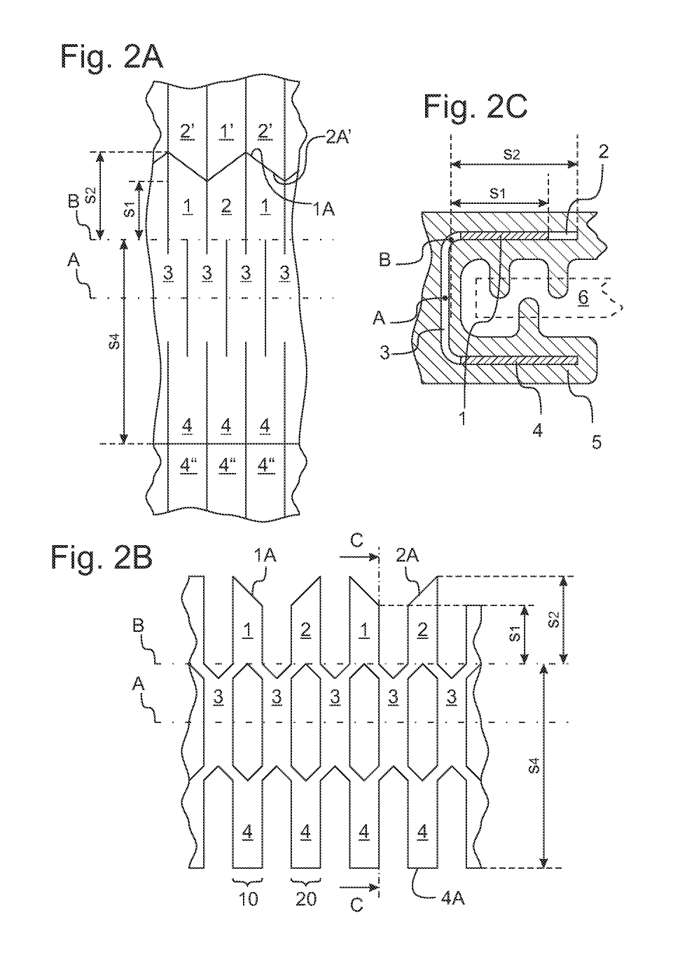

FIG. 2A-2C show in a manner corresponding to FIG. 1A-1C a part of an insert arrangement (FIG. 2A), of an insert of this insert arrangement (FIG. 2B) respectively of a motor vehicle seal of a passenger car with this insert (FIG. 2C). Features corresponding to one another are identified by identical reference numbers so that reference is made to the preceding description and only the differences are discussed in the following.

In the embodiment of FIG. 2A-2C the outer face ends 1A of the first legs 1 of the first frames 10 and the outer face ends 2A of the first legs 2 of the second frames 20 are inclined in opposite direction against the common bending axis B. Accordingly, the distance of the outer face ends 1A to the bending axis B over the width of the first legs 1 of the first frames 10 reduces to a minimum distance s₁, the distance of the outer face ends 2A to the bending axis B reduces over the width of the first legs 2 of the second frames 20 from a maximum distance s₂.

Accordingly, the minimum distance s₁ of the outer face ends 1A of the first legs 1 of the first frames 10 to the common bending axis B in leg longitudinal direction perpendicularly to the bending axis B is also smaller in this case than the maximum distance s₂ of the outer face ends 2A of the first legs 2 of the second frames 20 in leg longitudinal direction.

As is evident in FIG. 2A, the minimum distance as one of the outer face ends 1A of the first legs 1 of the in FIG. 2A middle, first insert to its bending axis B is opposite a maximum distance of an outer face end 2A′ of a first leg 2′ of the in FIG. 2A upper, second insert to its bending axis. The first legs 1, 2 of the first and second frames 10, 20 have the same minimum length s₁ and maximum length s₂ in leg longitudinal direction as is evident in particular in FIG. 2B.

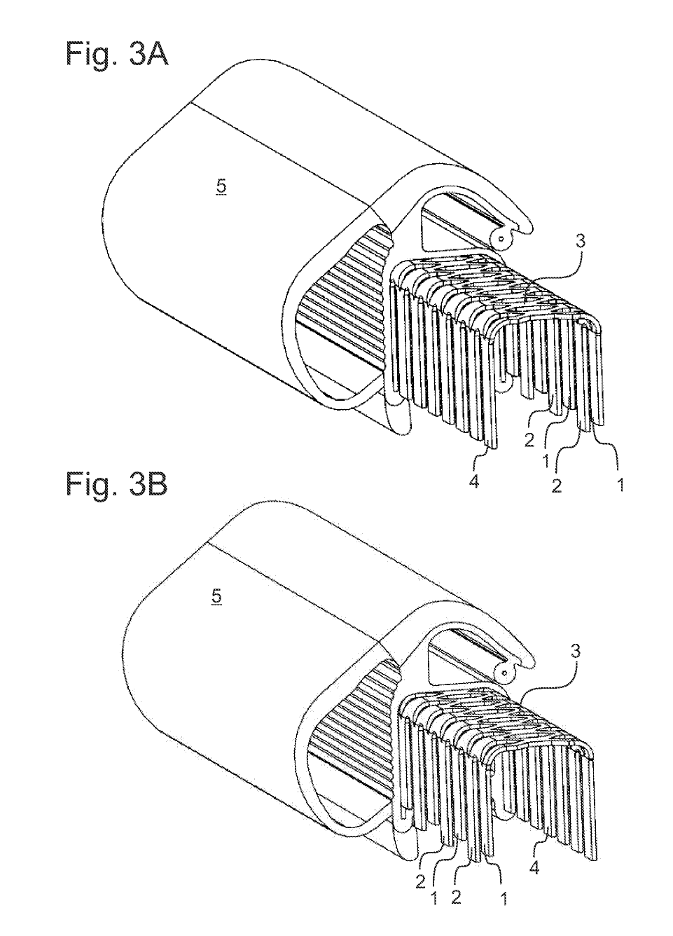

FIG. 3A shows a perspective view of a motor vehicle seal according to a further embodiment of the present disclosure. The same substantially corresponds to the embodiment described above with reference to FIG. 1A-1C. Features corresponding to one another are therefore identified by identical reference characters so that reference is made to the preceding description and only the differences discussed in the following. Evident is the U-shaped insert described above with reference to FIG. 1A-1C with the shorter first legs 1 of the first frames, the first legs 2 of the second frames which are longer compared with the former, the webs 3 connecting the frames and the second legs 4 of the first and second flames.

For illustration, a part of a profile 5 is cut away. In the embodiment of FIG. 3A, second legs 4 are arranged on the vehicle outside (left in FIG. 3A). FIG. 3B shows a perspective view of a modification of the motor vehicle seal of FIG. 3A according to a further embodiment of the present disclosure in a representation corresponding to FIG. 3A, in particular with partially cut-away profile 5. Features corresponding to one another are again identified by identical reference characters so that reference is made to the preceding description and only differences are discussed in the following. In the embodiment of FIG. 3B, second legs 4 are arranged on the vehicle inside (right in FIG. 3B).

Although in the preceding description exemplary embodiments were explained in is pointed out that a multitude of modifications is possible. Accordingly, the outer face ends 1A of the first legs 1 of the first frames 10 and the outer face ends 2A of the first legs 2 of the second frames 20 are inclined in opposite direction against the common bending axis B so that a garden fence-like outer contour of the insert is obtained. In a modification which is not shown, the outer face ends 1A of the first legs 1 of the first frames 10 and the outer face ends 2A of the first legs 2 of the second frames 20 can also be inclined in the same direction against the bending axis B.

In the exemplary embodiment of FIG. 2A-2C, the outer face ends 1A of the first legs 1 of the first frames 10 and the outer face ends 2A of the first legs 2 of the second frames 20 have the same maximum and the same minimum distance to the bending axis B. In a modification which is not shown, the outer face ends 1A of the first legs 1 of the first frames 10 and the outer face ends 2A of the first legs 2 of the second frames 20 can also have different maximum and/or minimal distances to the common bending axis B.

In the exemplary embodiment of FIG. 1A-2C, groups of a first frame 10 each and groups of a second frame 20 each are alternately arranged. In modifications which are not shown, the groups can also have multiple first respectively second frames each arranged, for example always alternately a first frame 10 and then two second frames 20, always alternately two first frames 10 and then a second frame 20 or always alternately two first frames 10 and two second frames 20.

Additionally or alternatively, the inserts in a modification which is not shown can still have other frames which are distinct from the first and second frames 10, 20. In the exemplary embodiment of FIG. 1A-1C, the first legs 2 and second legs 4 of the second frames 20 are symmetrical with respect to the adjoining webs 3 respectively insert longitudinal axis A, at least substantially or their outer face ends 2A, 4A, at least substantially, have the same maximum and minimum distance to a web middle. In other words, the first legs 2 in the exemplary embodiment of FIG. 1A-1C and second legs 4 of the second frames 20 are identical in length. In the exemplary embodiment of FIG. 2A-2C, the first legs 1, 2 and second legs 4 of the first and second frames 10, 20 are at least substantially symmetrical with respect to the adjoining webs 3 respectively insert longitudinal axis A or their outer face ends 1A, 2A, 4A have at least substantially the same maximum distance to a web middle. In other words, the first legs 1, 2 in the exemplary embodiment of FIG. 2A-2C and second legs 4 of the first and second frames 10, 20 are identical in length. In a modification which is not shown, the first and second legs of the first and/or second frames are asymmetrical with respect to the webs or insert longitudinal axis respectively their outer face ends have different maximum and/or minimum distances to a web middle. For example, the second legs 4 are shorter than the first legs 1 respectively too.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

1-14. (canceled)

15. An insert for a motor vehicle seal comprising a first frame and a second frame connected to the first frame via a web structures, which along an insert longitudinal axis includes adjacent first legs with outer face ends, wherein a minimum distance of the outer face ends of the first legs of the first frame to a bending axis of the first legs is less than a maximum distance of the outer face ends of the first legs of second frames to the bending axis of the first legs of the first frames.

16. The insert according to claim 15, wherein the outer face ends of the first legs of the first and second frames are parallel to the bending axis.

17. The insert according to claim 15, wherein the outer face ends of the first legs of the first and second frames are at least in sections inclined against the bending axis.

18. The insert according to claim 15, wherein the outer face ends of the first legs of the first frames and the outer face ends of the first legs of the second frames are inclined against the bending axis in the same direction.

19. The insert according to claim 15, wherein the outer face ends of the first legs of the first frames and the outer face ends of the first legs of the second frames are inclined against the bending axis in opposite directions.

20. The insert according to claim 15, wherein the outer face ends of the first legs of the first and second frames are curved against the bending axis. in particular are designed wave-like.

21. The insert according to claim 20, wherein the outer face ends of the first legs of the first and second frames are curved against the bending axis in a wave-like manner.

22. The insert according to claim 15, wherein at least one first frames and at least one second frames along the insert longitudinal axis (A) are alternately arranged.

23. The insert according to claim 15, wherein the first and second frames in each case have a second leg that is located opposite the first leg with an outer face end.

24. The insert according to claim 23, wherein the outer face ends of the second legs of the first and second frames have the same distance to the bending axis.

25. The insert according to claim 15, wherein the insert is severingly produced out of a plate.

26. The insert according to claim 15, wherein the frames comprise at least one of a U-shaped frame or Y-shaped frame.

27. An insert arrangement having at least two inserts according to claim 15 which are adjacent in leg longitudinal direction with parallel insert longitudinal axes (A), wherein the outer face ends of the first legs of the first frame of a first insert and the outer face ends of the first legs of the second frames of a second insert form a common separation plane.

28. A method for producing an insert arrangement according to claim 15, wherein the first and second insert are severed from a common separation plate.

29. A motor vehicle seal comprising a polymeric profile and an insert according to claim 15, which is at least partially arranged in the profile.

30. A motor vehicle comprising at least one motor vehicle seal according to claim 15, which is connected to a body panel of the motor vehicle.
